(19) United States
(12) Patent Application Publication
(10) Pub. No.: US 2010/0070274 A1
(43) Pub. Date: Mar. 18, 2010

(54) APPARATUS AND METHOD FOR SPEECH RECOGNITION BASED ON SOUND SOURCE SEPARATION AND SOUND SOURCE IDENTIFICATION

(75) Inventors: Hoon-Young CHO, Daejeon (KR); Sang Kyu Park, Daejeon (KR); Jun Park, Daejeon (KR); Seung Hi Kim, Daejeon (KR); Ilbin Lee, Daejeon (KR); Kyuwoong Hwang, Daejeon (KR); Hyung-Bae Jeon, Daejeon (KR); Yunkeun Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/498,544

(22) Filed: Jul. 7, 2009

(30) Foreign Application Priority Data
Sep. 12, 2008 (KR) 10-2008-0124371

(51) Int. Cl. G10L 15/20; G10L 21/02; G10L 15/14

(52) U.S. Cl. 704/233; 704/256.1; 704/226; 381/94.1; 704/E21.002; 704/E15.028

(57) ABSTRACT

An apparatus for a speech recognition based on source separation and identification includes: a sound source separator for separating mixed signals, which are input to two or more microphones, into sound source signals by using independent component analysis (ICA), and estimating direction information of the separated sound source signals; and a speech recognizer for calculating normalized log likelihood probabilities of the separated sound source signals. The apparatus further includes a speech signal identifier identifying a sound source corresponding to a user's speech signal by using both of the estimated direction information and the reliability information based on the normalized log likelihood probabilities.

### CROSS-REFERENCE(S) TO RELATED APPLICATION

The present invention claims priority of Korean Patent Application No. 10-2008-0124372, filed on Dec. 09, 2008, which is incorporated herein by reference.

### FIELD OF THE INVENTION

The present invention relates to a speech recognition system based on a microphone array and, more particularly, to an apparatus and method for high-performance speech recognition based on sound source separation and sound source identification, wherein source signals are separated from mixed sound signals using independent component analysis (hereinafter, referred to as “ICA”).

### BACKGROUND OF THE INVENTION

Speech recognition enables extraction of linguistic information from a user's speech signal, and conversion of the extracted linguistic information into character strings. The recognition rate becomes high in a relatively quiet environment. However, speech recognition systems are mounted in a computer, robot and mobile terminal, and may be used in various environments such as a living room, exhibit hall, laboratory, public place and the like. In these environments, various types of noises are present. Noise is one of major factors that lower the performance of the speech recognition system, and many noise handing technique have been developed to suppress noise.

Recently, technique to handle noises input from two or more microphones have been introduced. As these techniques, a beamforming technique, which strengthens a user's speech signal coming from a given direction while attenuating noise signals coming from other directions, and an independent component analysis (ICA) method, which separates original sounds from mixed sound signals by a statistical learning algorithm, are well known in the art.

In an apparatus receiving speech such as a speech recognizer or wired/wireless phone, ICA can be applied to effectively remove or suppress noises and interfering signals generated from noise sources such as neighborhood speakers, televisions, audio units and the like, but the noises to be removed or suppressed may be limited to point noise sources other than diffuse noise sources. Mixed sound signals formed of plural sound sources are reasonably well separated into the original sound signals by the ICA, however, the separated original sound sources are difficult to be indentified.

In other words, the conventional speech recognition techniques applied with ICA can separate source signals from the mixed sound signals, but cannot identify each of the separated sound signals, through the use of a speech recognizer. That is, it is necessary to accurately identify a sound signal of a particular user among the separated sound signals, but conventional techniques do not provide a solution in this respect.

### SUMMARY OF THE INVENTION

Therefore, the high-performance present invention provides an apparatus and method for speech recognition based on sound signal separation and sound signal identification wherein sources are separated by using ICA.

The present invention further provides an apparatus and method for speech recognition based on sound signal separation and sound signal identification wherein sound signals input to microphones are separated by using the ICA, which is capable of automatically identifying the user's speech intended to be recognized from the separated sound signals.

In accordance with an aspect of the present invention, there is provided an apparatus for a speech recognition based on source separation and identification including: a sound source separator for separating mixed signals, which are input to two or more microphones, into sound source signals by using independent component analysis (ICA), and estimating direction information of the separated sound source signals; a speech recognizer for calculating log likelihood probabilities of the separated sound source signals by normalizing the separated source signals; and a speech signal identifier identifying a sound source corresponding to a user's speech signal by using the estimated direction information and reliability to identification of the separated sound source signals based on the normalized log likelihood probabilities.

In accordance with another aspect of the present invention, there is provided a method for speech recognition based on source separation and source identification, including: separating mixed signals, which are input to two or more microphones, into source signals by using independent component analysis (ICA), and estimating direction information (direction of arrival, DOA) of the separated sound source signals; calculating normalized log likelihood probabilities of the separated sound source signals; and identifying a sound source corresponding to a user's speech signal using the estimated direction information and the reliability scores based on the normalized log likelihood probabilities.

In accordance with the present invention, a speech recognizer can be used without significant performance degradation even in an environment such as a living room or exhibit hall where multiple point noise sources are present, enabling development of diverse application systems based on speech recognition.

In addition, the user can give a talk at any location without a restriction such as speaking in the front of or in a given direction from the speech recognizer in virtue of the source identification functionality of the present invention, significantly enhancing user convenience.

### BRIEF DESCRIPTION OF THE DRAWINGS

The objects and features of the present invention will become apparent from the following description of embodiments given in conjunction with the accompanying drawings, in which:

FIG. 1 is a block diagram of a speech recognition apparatus based on source separation and source identification in accordance with an embodiment of the present invention;

FIG. 2 is a graph illustrating DOA (Directions Of Arrival) calculation for each source using a frequency domain ICA unmixing matrix;

FIG. 3 illustrates reliability distribution curves and a threshold value for user speech identification; and

FIG. 4 is a flow chart illustrating a procedure for speech recognition in accordance with the present invention.

### DETAILED DESCRIPTION OF THE EMBODIMENTS

Hereinafter, embodiments of the present invention will be described in detail with reference to the accompanying drawings.

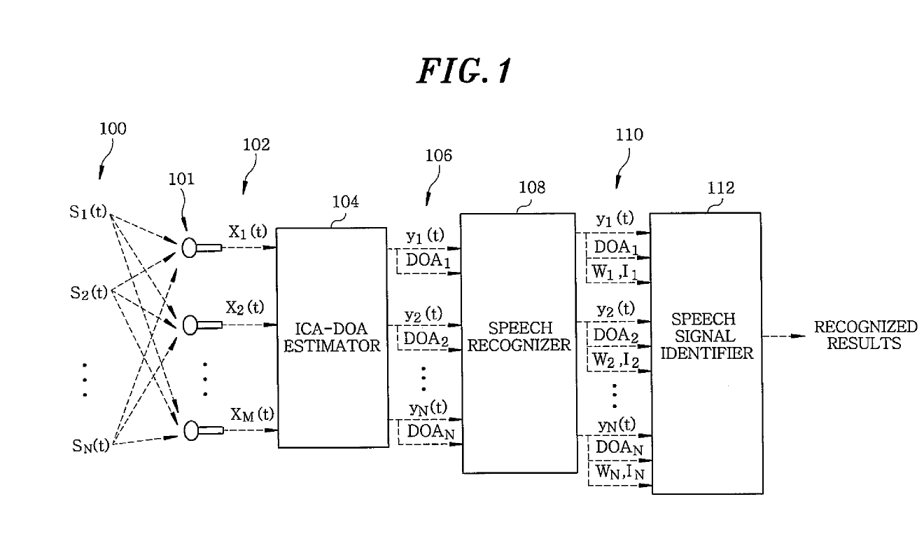

FIG. 1 is a block diagram of a speech recognition apparatus based on sound source separation and sound source identification in accordance with an embodiment of the present invention.

As shown in FIG. 1, the speech recognition apparatus includes an ICA-DOA (Independent Component Analysis and Directions Of Arrival) estimator 104, a speech recognizer 108 and speech signal identifier 112. First of all, it is assumed that N sound sources are present in the environment of the speech recognition apparatus. Among the N sound sources, one source is a user's sound source (user's speech) using the apparatus, and the other N-1 sound sources are from noise sources. These sound sources are denoted by s₁(t), . . . , s_{N}(t) 100.

M microphones are arranged at regular intervals in the speech recognition apparatus, and M mixed sound signals input through the microphones are indicated by x₁(t), . . . , x_{M}(t) 102. If the impulse response on the acoustic propagation path from a sound source n to a microphone m is denoted by hₘₙ(l), Equation 1 below holds:

$${x}_{m} ( t ) = {\sum }_{n = 1}^{N} {\sum }_{l} {h}_{mn} ( l ) {s}_{n} ( t - l ) \qquad [ Equation 1 ]$$

The ICA-DOA estimator 104 serves as a sound separator, which separates source signals from signals input to the microphones xₘ(t) to obtain separated signals yₙ(t) using Equation 2 below. In this regard, ICA is a representative approach to obtain wₙₘ(l) corresponding to the inverse of hₘₙ(l).

$${y}_{n} ( t ) = {\sum }_{m = 1}^{M} {\sum }_{l = 0}^{L - 1} {w}_{nm} ( l ) {x}_{m} ( t - l ) \qquad [ Equation 2 ]$$

Equations 1 and 2 can be respectively converted into frequency domain representations through Fast Fourier Transform (FFT) as shown in Equation 3.

Xₘ(f,t)=Hₘₙ(f)Sₙ(f,t),

Yₙ(f,t)=Wₙₘ(f)Xₘ(f,t) [Equation 3]

That is, in a frequency domain ICA, the microphone input signals xₘ(t) in time domain is converted into frequency domain, and the unmixing matrix wₙₘ(f) is obtained by repeatedly executing a learning rule given by Equation 4 by using an initial value.

Wₙₘ(f)←Wₙₘ(f)+ΔWₙₘ(f),

ΔWₙₘ(f)=μ·(I−E[Φ(Yₙ)Yₙ^{H}])·Wₙₘ(f) [Equation 4]

After calculating Yₙ(f,t) (separated signals in the frequency domain) by using the Equation 3 on the basis of the learned unmixing matrix Wₙₘ(f), separated sound signals yₙ(t) in the time domain are finally obtained through Inverse Fourier Transform.

Although separated sound signals y₁(t), . . . , yₙ(t) can be obtained with the ICA, their corresponding original sound sources are not known. Hence, it is necessary for the speech recognition apparatus to automatically identify the speech signal of the user among these separated sound signals yₙ(t).

To calculate directions of arrival (DOA) of the sound sources, the frequency response matrix (or mixing matrix) Hₘₙ(f) is obtained first from the learned unmixing matrix Wₙₘ(f) by Hₘₙ(f)=Wₙₘ⁻¹(f). Herein, the separated sound signals may be exchanged in order (permutation problem) and scaled in amplitude (scaling problem) due the characturistics of ICA, and the response matrix Hₘₙ(f) can be represented as Hₘₙ(f)=Aₘₙ·exp(jφₙ)exp(j2πfc⁻¹dₘcosθ_{n,f}). Here, Aₘₙ and exp(jφₙ) respectively denote amplitude attenuation and phase modulation from the original sound signals.

The ratio between two frequency response matrices Hₘₙ(f) and H_{m′n}(f) can be calculated by Equation 5 below.

Hₘₙ(f)/H_{m′n}(f)=Aₘₙ/A_{m′n}exp(j2πfc⁻¹(dₘ−d_{m′})cosθ_{n,f}) [Equation 5]

As Equation 5 indicates a frequency response ratio with respect to an identical sound source n, Aₘₙ/A_{m′n}≈1. Therefore, DOA θ_{n,f} of the separated signal yₙ(t) at a frequency f can be calculated by using Equation 6 below.

$${θ}_{n , f} = {cos}^{- 1} \frac{angle ( {H}_{mn} / {H}_{{m}^{′} n} )}{2 π {fc}^{- 1} ( {d}_{m} - {d}_{{m}^{′}} )} \qquad [ Equation 6 ]$$

In Equation 6, constant c denotes the speed of sound (340 m/s).

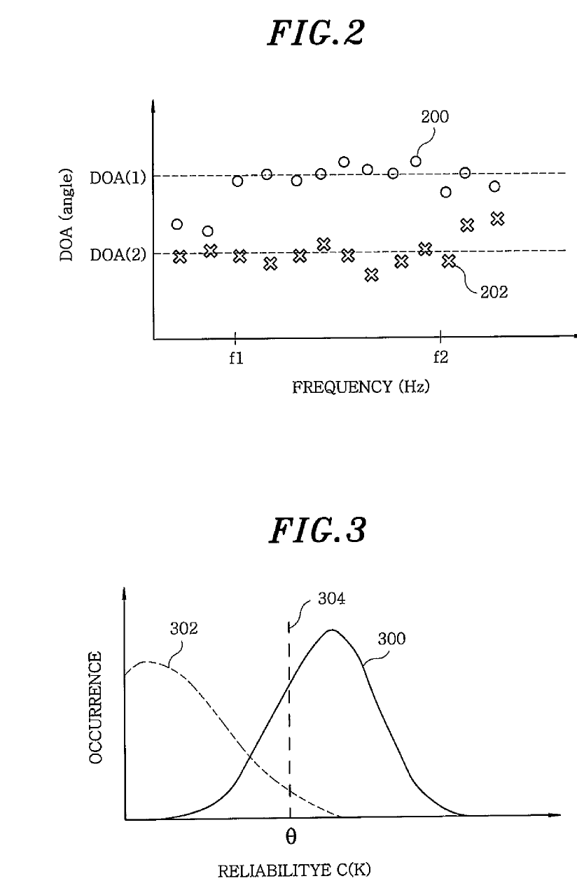

FIG. 2 is a graph illustrating DOA calculation for each sound source using an ICA unmixing matrix in the frequency domain. In FIG. 2, the angle related to a sound source 1 calculated from the unmixing matrix against the frequency is plotted as a circle 200, and the angle related to a sound source 2 is plotted as a cross 202.

That is, for two sound sources, values of DOA(1) θ_{1,f} and DOA(2) θ_{2,f} at different frequencies are plotted as a circle 200 or a cross 202. θ_{1,f} and θ_{2,f} can have slightly different values at different frequencies, and tend to have less accurate values at low frequencies or high frequencies. Thus, it is preferable to calculate the direction DOA(n) of the separated signal yₙ(t) by averaging values of θ_{n,f} over the entire frequencies or an interval [f1, f2] having a highly reliable value over the entire frequencies, as shown in Equation 7.

$$DOA ( n ) = \frac{1}{( f 2 - f 1 + 1 )} {\sum }_{f = f 1}^{f 2} {θ}_{n , f} \qquad [ Equation 7 ]$$

As described above, the directions DOA(n) of the separated sound signals y₁(t), . . . , yₙ(t) can be obtained through the ICA-DOA estimator 104. Thereafter, in the speech recognizer 108, in order to calculate a speech recognition reliability of the separated sound signals y₁(t), . . . , yₙ(t), a k-dimensional feature vector with respect to each of the separated sound signals y₁(t), . . . , yₙ(t) is calculated during a preset interval (e.g., an interval of 20 ms for each 10 ms. When N feature vectors extracted respectively from the separated sound signals y₁(t), . . . , yₙ(t) are denoted by Z₁, . . . , Zₙ, and a search network formed with a set of hidden Markov models (HMM) as a probabilistic model for speech recognition is denoted by λ, the normalized log likelihood probability lₙ of the separated sound signal yₙ(t) can be calculated by following Equation 8.

lₙ=max log(Pr(Zₙ|λ))/T [Equation 8]

As the log likelihood probability accumulates with increasing length of a speech, it is divided by the number of frames T in the entire signal interval for normalization. If one of the separated sound signals y₁(t), . . . , yₙ(t) corresponds to the user's speech, it is highly likely that the corresponding separated sound signal has the highest probability through the operation of the HMM search network. Thus, if lₖ is the maximum among the calculated normalized log likelihood probabilities l₁, . . . , lₙ, the kth separated signal yₖ(t) is considered as the user's speech.

However, in reality, signals separated by ICA do not include the original sound source only, and may still include other sound source or an interfering neighborhood speakers' speech signal. Therefore, the kth separated signal yₖ(t) having the maximum log likelihood probability lₖ can be a sound signal other than the user speech signal.

Therefore, the present embodiment additionally utilizes reliability information regarding a separated signal yₖ(t) being presumed as the user speech signal with the maximum log likelihood probability lₖ. The reliability is defined by the difference between the highest value lₖ and the second highest value l_{second} of the obtained log likelihood probabilities 1₁, . . . , 1_{N}. That is, the reliability is defined as c(k)=|lₖ−l_{second}|. In this case, when the difference between lₖ and l_{second} is higher than a specific threshold value, yₖ(t) is considered as the user speech signal.

FIG. 3 illustrates reliability distribution curves and a threshold value for user speech identification.

In FIG. 3, when the separated signal yₖ(t) is the user speech signal, the reliability c(k) thereof follows a right side distribution 300. On the other hand, when the separated signal yₖ(t) is a noise signal, the difference between lₖ and l_{second} is not large and thus the reliability c(k) thereof follows a left side distribution 302. Reference numeral 304 indicates an experimentally derived threshold value θ.

As described above, separated signals yₗ(t), . . . , yₙ(t) and their direction information DOA(1), . . . , DOA(n) (106) are derived from input signals xₗ(t), . . . , x_{M}(t) 102 by the ICA-DOA estimator 104, normalized log likelihood probabilities l₁, . . . , l_{N} are calculated by the speech recognizer 108, and the reliability c(k) is calculated by the speech signal identifier 112, the reliability c(k) being a reliability of the maximum normalized log likelihood probability lₖ (lₖ=max{l₁, . . . , lₙ}).

In addition, in accordance with the embodiment of the present invention, the position of noise sources other than the user's speech is considered to be unmovable. Therefore, the present invention further enhances the performance of user speech identification.

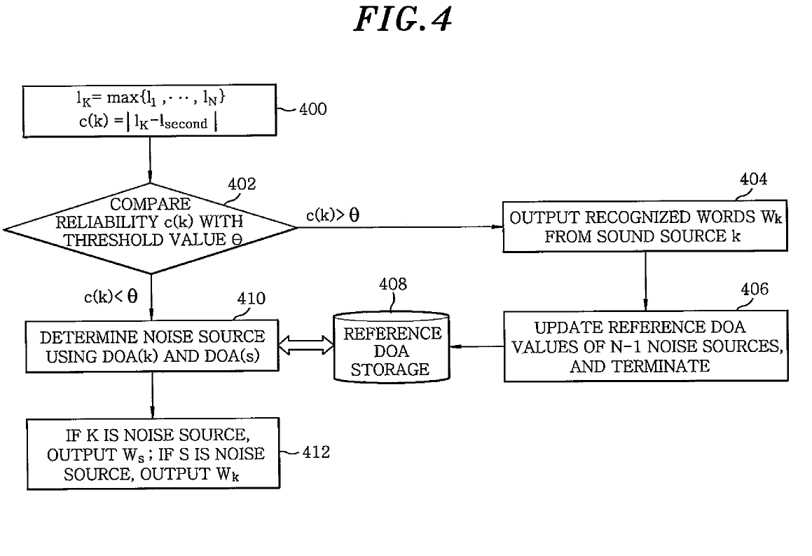

FIG. 4 is a flow chart illustrating a procedure for performing speech recognition.

Referring to FIG. 4, at step 400, the reliability c(k) for a sound source k with the maximum probability is calculated, and at step 402, the reliability c(k) is compared with a threshold value θ 304 which is experimentally derived (see, FIG. 3). If the reliability c(k) is greater than the threshold value θ, i.e., the reliability is significantly high, one or more words Wₖ derived from the speech recognition of sound source k are recognized as the user speech at step 404. At step 406, reference DOA values for the N-1 noise sources stored in a reference DOA storage 408 are updated with DOA values of the N-1 noise sources excluding the sound source k, and the procedure is ended.

At step 406, DOA(i) of each of the N-1 noise sources excluding the sound source k is compared with reference DOA values stored in the reference DOA storage 408, and one reference DOA value closest to DOA(i) is found and updated. If the reference DOA of the jth noise source is ref_DOA(r), ref_DOA(r) can be updated by ref_DOA(r)←(1−ρ)·ref_DOA(r)+ρ·DOA(j) (0≦ρ≦1). The reason for updating the reference DOAs is that even though the position of noise sources are assumed to be fixed, the estimated DOA values are slightly different each time they are calculated. Also, the initial value of ref_DOA(r) are obtained with setting the ρ value as ρ=1, and thereafter the update continues with other predetermined ρ value as above.

Meanwhile, at step 402, if the reliability c(k) is less than the threshold value θ, sound source identification is performed by using DOA(k) for the sound source k with the highest output probability and DOA(s) for the sound source S with the second highest output probability at step 410. That is, one of the reference DOA values, for the N-1 noise sources stored in the reference DOA storage 408, closest to DOA(k) is found, and the difference DOA_diff(k) between DOA(k) and the found reference DOA value is calculated. Similarly, the difference DOA_diff(s) is calculated. Then, between DOA_diff(k) and DOA_diff(s), higher one is determined as a the user's speech and the other is determined as a noise source. Finally, at step 412, according to the result of source identification, one or more words Wₛ from the source s are recognized as the user speech if the source k is determined as a noise source, and one or more words Wₖ are recognized as the user speech if the source s is determined as a noise source.

As described above, the present invention performs separation of sound source signals by using the ICA for high-performance speech recognition. Herein, input signals to microphones are separated using the ICA, the user's speech signal is automatically identified from the separated source signals.

As described above, speech recognition based on source separation and source identification is a speech recognition technique resistant to noise. Audio source separation can be successfully performed in a noisy environment on the basis of two or more microphones and the ICA, and thus may be applied to diverse fields related to wireless headsets, hearing aids, mobile phones, speech recognizers, and medical image analysis.

While the invention has been shown and described with respect to the preferred embodiments, it will be understood by those skilled in the art that various changes and modifications may be made without departing from the spirit and scope of the invention as defined in the following claims.

What is claimed is:

1. An apparatus for a speech recognition based on source separation and identification, comprising:
a sound source separator for separating mixed signals, which are input to two or more microphones, into sound source signals by using independent component analysis (ICA), and estimating direction information of the separated sound source signals;
a speech recognizer for calculating normalized log likelihood probabilities of the separated sound source signals; and
a speech signal identifier identifying a sound source corresponding to a user's speech signal by using the estimated direction information and reliability information based on the normalized log likelihood probabilities.

2. The apparatus of claim 1, wherein, under an assumption that noise sources are not moveable, the speech signal identifier estimates reference direction information of noise sources by using the estimated direction information and the obtained reliability.

3. The apparatus of claim 1, wherein the reference direction information of noise sources is updated with direction information of the noise sources output from the speech signal identifier.

4. The apparatus of claim 1,
wherein the sound source separator converts the mixed signals in a time domain into a frequency domain through Fast Fourier Transform; computes an unmixing matrix by repeatedly executing a learning rule of an ICA algorithm; and obtains separated signals in the time domain by converting separated signals in a frequency domain through Inverse Fourier Transform, the separated signals in the frequency domain being calculated by using the unmixing matrix.

5. The apparatus of claim 4, wherein the direction information of the separated source signals is determined in the sound source separator by obtaining two frequency response matrices from the unmixing matrix, deriving direction information of each of the separated source signals at a given frequency by using a ratio between the two frequency response matrices, and by averaging values of the latter direction information over the entire frequencies or an interval having a highly reliable value in the entire frequency band.

6. The apparatus of claim 1, wherein the speech recognizer calculates feature vectors for the sound source signals separated by the sound source separator at regular intervals, and calculates the normalized log likelihood probabilities by using the calculated feature vectors and a search network employing a hidden Markov model.

7. The apparatus of claim 1, wherein the speech recognizer determines, when a normalized log likelihood probability lₖ is highest among the calculated normalized log likelihood probabilities, the kth separated sound source signal as the user's speech signal.

8. The apparatus of claim 6, wherein the user speech signal identifier calculate, as reliability information for determining a first sound source of the highest normalized log likelihood probability lₖ as the user's speech signal, the reliability defined by a difference between the highest normalized log likelihood probability lₖ and a second highest normalized log likelihood probability.

9. The apparatus of claim 8, wherein, when the reliability is greater than a preset threshold value, the user speech signal identifier outputs recognized one or more words of the first sound source corresponding to the reliability as a user's speech, otherwise, sound source identification is performed by using respective direction information of the first sound source of the highest normalized log likelihood probability lₖ and a second sound source of the second highest normalized log likelihood probability

10. The apparatus of claim 9, wherein the user speech signal identifier finds, when the reliability is less than or equal to the threshold value, a first reference value among reference direction information of noise sources closest to the direction information of the first sound source, calculates a first difference between the direction information of the first sound source and the found first reference value, finds a second reference value among the reference direction information of the noise sources closest to the direction information of the second sound source, and calculates a second difference between the direction information of the second sound source and the found second reference value; and
determines the first sound source and second sound source as the user speech and a noise source, respectively, when the first difference is greater than the second difference, and determines the second sound source and first sound source as the user speech and a noise source, respectively, when the first difference is less than the second difference.

11. The apparatus of claim 9, wherein the user speech signal identifier includes a reference DOA storage storing, when the reliability is greater than the threshold value, the direction information of noise sources excluding the sound source corresponding to the reliability to the reference DOA update unit.

12. The apparatus of claim 11, wherein the reference DOA update unit compares the direction information of each noise source with existing reference direction information to find one of the reference direction information closest to the direction information, and updates the found reference direction information with a calculation result of the direction information and the found reference direction information.

13. A method for speech recognition based on source separation and source identification, comprising:
separating mixed signals, which are input to two or more microphones, into source signals by using independent component analysis (ICA), and estimating direction information (direction of arrival, DOA) of the separated sound source signals;
calculating normalized log likelihood probabilities of the separated sound source signals by normalizing the log likelihood values of separated source signals; and
identifying a sound source corresponding to a user's speech signal using the estimated direction information and reliability information based on the normalized log likelihood probabilities.

14. The method of claim 13, wherein, under an assumption that noise sources are not movable, said identifying the sound source includes estimating reference direction information of noise sources by using the estimated direction information and the reliability.

15. The method of claim 14, wherein said separating the mixed signals includes:
converting the mixed signal in a time domain into a frequency domain through Fast Fourier Transform, computing unmixing matrix by repeatedly executing a learning rule of an ICA algorithm, and obtaining the separated source signals in the time domain by converting separated signals in a frequency domain through Inverse Fourier Transform, the separated signals in the frequency domain being calculated by using the unmixing matrix; and
obtaining two frequency response matrices from the unmixing matrix, and deriving direction information of each of the separated source signals at a given frequency by using a ratio between the two frequency response matrices, and determining the direction information of the separated source signals by averaging values of the direction information over the entire frequencies or an interval having a highly reliably value in the entire frequency band.

16. The method of claim 13, wherein calculating the normalized log likelihood probabilities comprises:
calculating feature vectors for the sound source signals separated by the sound source separator at regular intervals; and
calculating normalized log likelihood probabilities by using the calculated feature vectors and a search network employing a set of hidden Markov models.

17. The method of claim 13, wherein said calculating the normalized log likelihood probabilities includes determining, when a normalized log likelihood probability lₖ is highest among the calculated normalized log likelihood probabilities, the kth separated sound source signal as the user's speech signal.

18. The method of claim 13, wherein said identifying the sound source includes calculating, as reliability information for determining a first sound source of the highest normalized log likelihood probability lₖ as the user's speech signal, the reliability defined by a difference between the highest normalized log likelihood probability lₖ and a second highest normalized log likelihood probability.

19. The method of claim 18, wherein said identifying the sound source includes:
when the reliability is greater than a preset threshold value, outputting recognized one or more words of the first sound source corresponding to the reliability as a user's speech,
otherwise, performing source identification by using respective direction information of the first sound source of the highest normalized log likelihood probability lₖ and a second sound source with the second highest normalized log likelihood probability.

20. The method of claim 19, wherein said identifying the sound source includes:
finding, when the reliability is less than or equal to the threshold value, a first reference value among reference direction information of noise sources closest to the direction information of the first sound source, and calculating a first difference between the direction information of the first sound source and the found first reference value, a second reference value among reference direction information of noise sources closest to the direction information of the second sound source, and calculating a second difference between the direction information of the second sound source and the found second reference value; and
determining the first sound source and second sound source as the user speech and a noise source, respectively, when the first difference is greater than the second difference, and determining the second sound source and first sound source as the user speech and a noise source, respectively, when the first difference is less than the second difference.
